(19) United States
(12) Patent Application Publication
(10) Pub. No.: US 2013/0063555 A1
(43) Pub. Date: Mar. 14, 2013

(54) IMAGE PROCESSING DEVICE THAT COMBINES A PLURALITY OF IMAGES

(71) Applicants: Kosuke MATSUMOTO, Tokyo (JP); Naotomo Miyamoto, Tokyo (JP)

(72) Inventors: Kosuke MATSUMOTO, Tokyo (JP); Naotomo Miyamoto, Tokyo (JP)

(73) Assignee: CASIO COMPUTER CO., LTD., Tokyo (JP)

(21) Appl. No.: 13/606,540

(22) Filed: Sep. 7, 2012

(30) Foreign Application Priority Data
Sep. 8, 2011 (JP) 2011-196368

(51) Int. Cl. G06K 9/36; H04N 7/00

(52) U.S. Cl. 348/38; 382/284; 348/E07.001

(57) ABSTRACT

An image capturing device (1) includes an energy calculation unit (52), energy minimum path search unit (54), range search unit (55), α blend width determination unit (56), transmittance setting unit (58), and combination unit (59). The energy calculation unit (52) respectively calculates energy values for pixels in a first image based on the first image and a second image. The energy path determination unit (54) determines a path in the first image based on the calculated energy values. The range search unit (55) determines, in the first image, for a range of pixels whose energy values are close to one of the calculated energy values on the determined path.

This application is based on and claims the benefit of priority from Japanese Patent Application No. 2011-196368, filed on 8 Sep. 2011, the content of which is incorporated herein by reference.

### BACKGROUND OF THE INVENTION

1. Field of the Invention

The present invention relates to an image processing device, image processing method, and a recording medium.

2. Related Art

As a conventional technology, Japanese Unexamined Patent Application, Publication No. H11-282100 describes a technology that generates image data of a wide range such as a panoramic image, by combining the image data of a plurality of images captured consecutively so that the same characteristic points of the plurality of images match.

However, it is generally difficult to make the image capturing conditions perfectly match in a plurality of images, such as the influences due to shedding, timing of pressing the shutter button, and exposure timing of imaging element. As a result, in a case of generating the data of one image of wide range by combining the data of a plurality of images, the data of the combined image of wide range is influenced by the differences in exposure values due to differences in the image capturing conditions of each of the plurality of images.

In addition, the data of an image of wide range may be generated by capturing a plurality of images while moving the image capturing device in two dimensions, and then combining the data of this plurality of images. In this case, the data of the image of wide range generated will have respectively different exposure values in the plurality of images, even if adopting the above combining technology of Japanese Unexamined Patent Application, Publication No. H11-282100; therefore, there have been cases of aligning of the characteristic points not having been accurately carried out, and contrast inconsistency or the like occurring at the connecting portions of images. As a result, there has been concern over viewers having the impression of a sense of strangeness when the combined image of a wide range is displayed.

### SUMMARY OF THE INVENTION

The present invention has been made taking such a situation into consideration, and has an object of decreasing the sense of strangeness about a connecting portion in a combined image of a wide range.

In order to achieve the above-mentioned object, an image processing device according to a first aspect of the present invention includes:

a receiving unit that receives a first image and a second image that is a combination target of the first image; an energy calculation unit that calculates energy values for pixels in the first image based on the first image and the second image;

an energy path determination unit that determines a path in the first image based on the calculated energy values;

a range search unit that determines, in the first image, a range of pixels whose energy values are close to one of the calculated energy values on the determined path;

a blend width determination unit that determines, based on the determined range of pixels, a blend width between the first image and the second image;

a transmittance setting unit that sets, based on the determined blend width, a transmittance between the first image and the second image; and

a combination unit that combines the first image and the second image, based on the determined blend width and the set transmittance.

In addition, in an image processing method executed by an image processing device according to one aspect of the present invention, the method includes the steps of:

receiving a first image and a second image that is a combination target of the first image;

calculating energy values for pixels in the first image based on the first image and the second image, respectively;

determining a path in the first image based on the calculated energy values;

determining, in the first image, for a range of pixels whose energy values are close to one of the calculated energy values on the determined path;

determining, based on the determined range of pixels, a blend width between the first image and the second image;

setting, based on the determined blend width, a transmittance between the first image and the second image; and

combining the first image and the second image, based on the determined blend width and the set transmittance.

Furthermore, in a recording medium that records a computer readable program according to one aspect of the present invention, the program causes the computer to execute the steps of:

receiving a first image and a second image that is a combination target of the first image;

calculating, energy values for pixels in the first image based on the first image and the second image, respectively;

determining a path in the first image based on the calculated energy values;

determining, in the first image, for a range of pixels whose energy values are close to one of the calculated energy values on the determined path;

determining, based on the determined range of pixels, a blend width between the first image and the second image;

setting, based on the determined blend width, a transmittance between the first image and the second image; and

combining the first image and the second image, based on the determined blend width and the set transmittance.

### BRIEF DESCRIPTION OF THE DRAWINGS

FIG. 1 is a block diagram showing the hardware configuration of an image capturing device according to an embodiment of the present invention;

FIG. 2 is a schematic diagram showing an example of a data generation technique for a wide image;

FIG. 3 is a schematic diagram showing an outline of wide image combination processing of the image capturing device;

FIG. 4 is a schematic diagram showing an outline of vertical combination processing in the wide image combination processing;

FIG. 5 is a functional block diagram showing, among the functional configurations of the image capturing device of FIG. 1, the functional configuration for executing wide image combination processing;

FIG. 6 is a schematic diagram showing an example of an energy map generation technique of an energy map generation unit;

FIG. 7 is a schematic diagram showing an example of a technique for searching for an energy minimum path of an energy minimum path search unit;

FIG. 8 is a schematic diagram showing an example of a technique for searching for and determining a range of pixels having values close to the value of the specific pixel of interest in the data of one image on the energy minimum path of a range search unit;

FIG. 9 is a schematic diagram showing an example of a technique for determining a blend width of an α blend width determination unit;

FIG. 10 is a schematic diagram showing an example of a technique for generating an α blend map of an α blend map generation unit;

FIG. 11 is a flowchart illustrating the flow of wide image combination processing executed by the image capturing device; and

FIG. 12 is a flowchart illustrating the flow of vertical combination processing executed by the image capturing device.

### DETAILED DESCRIPTION OF THE INVENTION

Hereinafter, an image capturing device 1 as an example of an image processing device will be explained as an embodiment of the present invention while referencing the drawings.

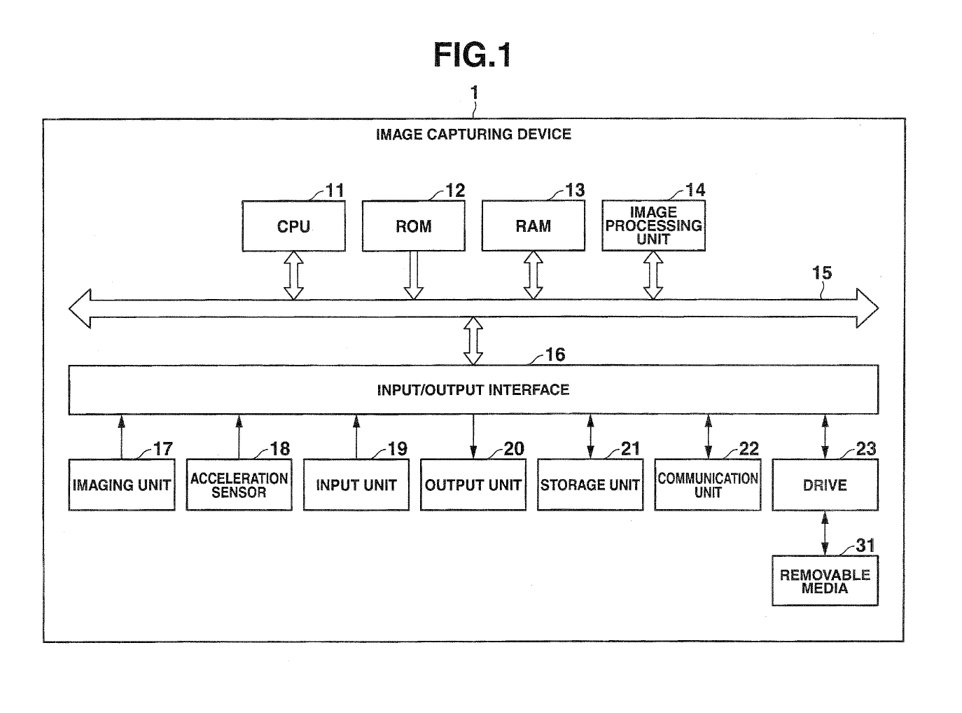

FIG. 1 is a block diagram showing the hardware configuration of the image capturing device 1 according to the embodiment of the present invention.

The image capturing device 1 is configured as a digital camera, for example.

The image capturing device 1 includes a CPU (Central Processing Unit) 11, ROM (Read Only Memory) 12, RAM (Random Access Memory) 13, an image processing unit 14, a bus 15, an input/output interface 16, an imaging unit 17, an acceleration sensor 18, an input unit 19, an output unit 20, a storage unit 21, a communication unit 22, and a drive 23.

The CPU 11 executes various processing in accordance with programs recorded in the ROM 12, or programs loaded from the storage unit 21 into the RAM 13.

The necessary data and the like upon the CPU 11 executing the various processing are also stored in the RAM 13 as appropriate.

The image processing unit 14 is configured from a DSP (Digital Signal Processor), VRAM (Video Random Access Memory), etc., and conducts various image processing on the data of images in cooperation with the CPU 11.

The CPU 11, ROM 12, RAM 13 and image processing unit 14 are connected together via the bus 15. The input/output interface 16 is also connected to this bus 15. The imaging unit 17, acceleration sensor 18, input unit 19, output unit 20, storage unit 21, communication unit 22 and drive 23 are connected to the input/output interface 16.

Although not illustrated, the imaging unit 17 includes an optical lens unit and an image sensor.

The optical lens unit is configured by a lens for condensing light, e.g., focus lens, zoom lens, etc. in order to capture the image of a subject.

The focus lens is a lens that causes a subject image to form on the light receiving surface of the image sensor. The zoom lens is a lens that causes the focal length to freely change in a certain range.

A peripheral circuit is also provided to the optical lens unit that adjusts setting parameters such as focal point, exposure and white balance as necessary.

The image sensor is configured from a photoelectric transducer, AFE (Analog Front End) and the like.

The photoelectric transducer is configured from a photoelectric transducer of CMOS (Complementary Metal Oxide Semiconductor) type, or the like. A subject image is incident from the optical lens unit to the photoelectric transducer. Therefore, the photoelectric transducer accumulates at a fixed time image signals by photoelectrically converting (imaging) the subject image, and sequentially provides the accumulated image signals as an analog signal to the AFE.

The AFE executes various signal processing such as A/D (Analog/Digital) conversion processing on this analog image signal. A digital signal is generated by way of various signal processing, and is outputted as an output signal of the imaging unit 17.

Herein, the output signal outputted from the imaging unit 17 by a one-time image capturing action is referred to as “data of frame image” hereinafter. In other words, since a continuous shoot action repeats the image capturing action a plurality of times, the data of a plurality of frame images is outputted from the imaging unit 17 in accordance with a continuous shoot action.

In the present embodiment, a normal image having an aspect ratio of 4:3 is used as a frame image.

The acceleration sensor 18 is configured to be able to detect the velocity and acceleration of the image capturing device 1.

The input unit 19 is configured by various buttons and the like, and allows for inputting various information in accordance with instruction operations of a user.

The output unit 20 is configured by a display, speaker, etc., and outputs images and sound. A display having an aspect ratio of 4:3 is provided to the output unit 20 of the present embodiment so as to enable the display of a normal image on the entire screen.

The storage unit 21 is configured by a hard disk, DRAM (Dynamic Random Access Memory), etc., and stores the data of various images.

The communication unit 22 controls communication carried out with another device (not illustrated) via a network including the Internet.

Removable media 31 made from a magnetic disk, optical disk, magneto-optical disk, semiconductor memory, or the like is installed in the drive 23 as appropriate. Programs read from the removable media 31 by the drive 23 are installed in the storage unit 21 as necessary. In addition, similarly to the storage unit 21, the removable media 31 can also store various data such as the data of images stored in the storage unit 21.

The image capturing device 1 having such a configuration can execute wide image combination processing.

In the present embodiment, “wide image combination processing” is a sequence of processing from causing a continuous shoot action in the imaging unit 17, generating data of a plurality of panoramic images by combining the data of a plurality of frame images obtained as a result thereof, until generating a wide image by combining the data of the plurality of these generated panoramic images.

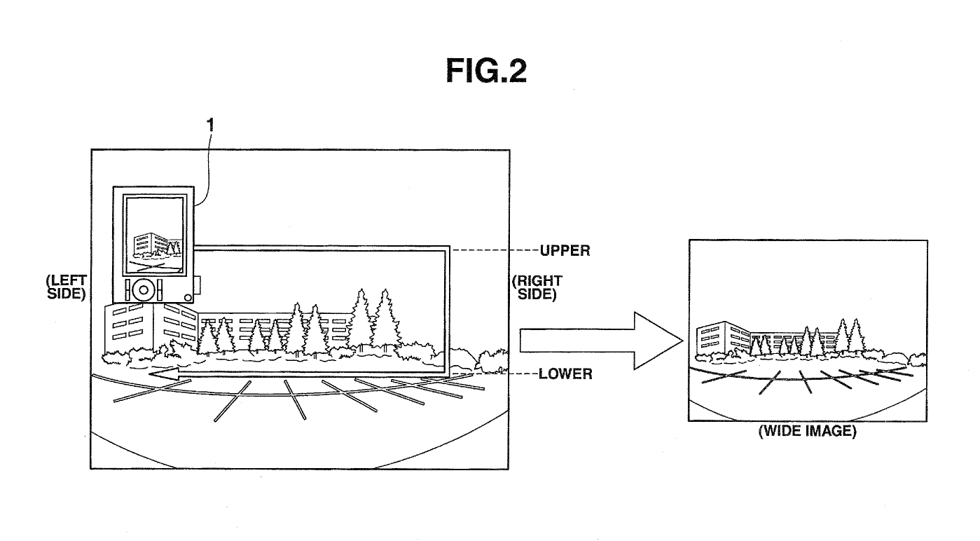

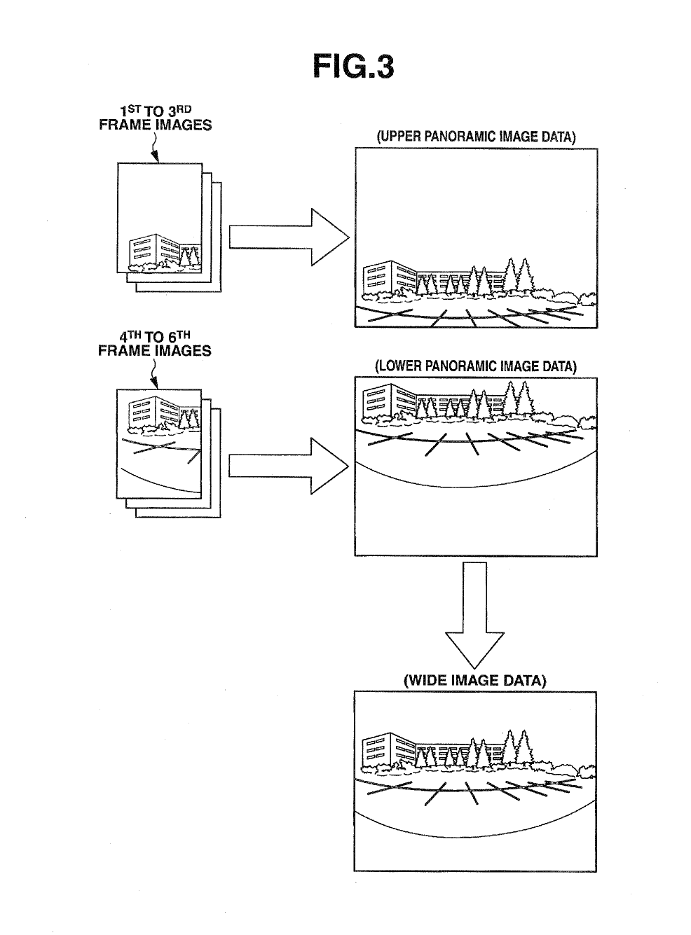

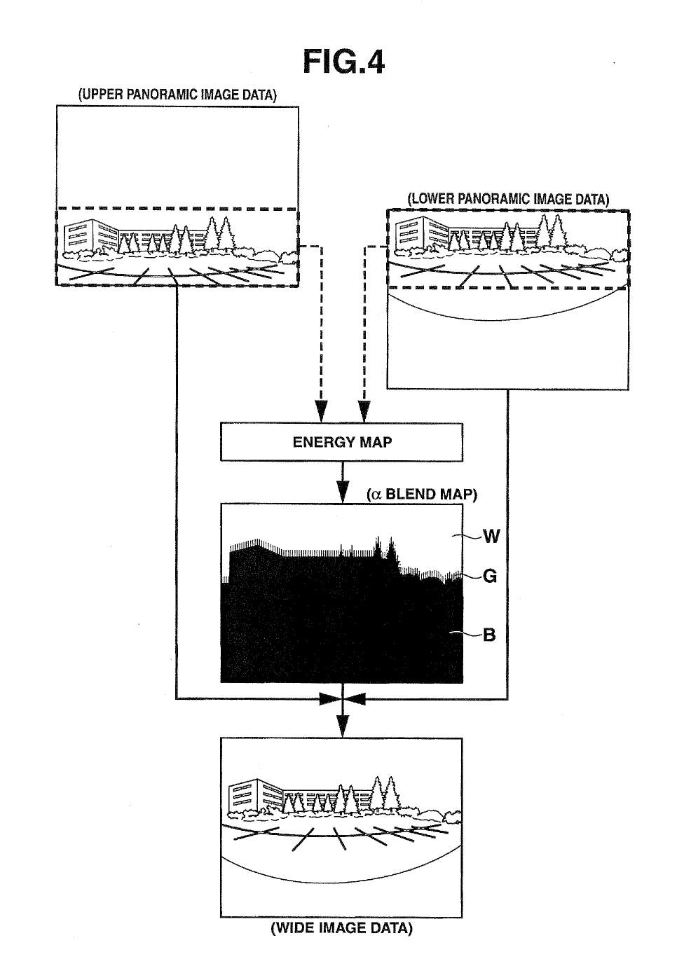

Herein, in order to facilitate understanding of wide image combination processing, an outline of wide image combination processing will be explained. In the explanation of the output of wide image combination processing, first, an outline of data generation technique for a wide image in the image capturing device 1 will be explained referencing FIG. 2, and then, referencing FIG. 3, an outline of wide image combination processing in the image capturing device 1 will be explained, and referencing FIG. 4, an outline of vertical combination processing of the wide image combination processing will be explained.

FIG. 2 is a schematic diagram showing an example of a data generation technique for a wide image.

In FIG. 2, an example of a case of a user capturing an image of a building as the wide image is illustrated. In the present embodiment, the direction from the left side to right side or right side to left side is referred to as “horizontal direction”, and the direction from above to below or from below to above is referred to as “vertical direction”. In addition, in the present embodiment, the image generated by combining data of a plurality of frame images in the horizontal direction is referred to as “panoramic image”, and the image of a wide range generated by combining data of a plurality of panoramic images is referred to as “wide image”.

In the present embodiment, a mode of capturing a normal image (hereinafter referred to as “normal mode”) and a mode of capturing a wide image (hereinafter referred to as “wide mode”) exist as operating modes of the image capturing device 1.

Therefore, the user switches the operating mode of the image capturing device 1 to the wide mode by making a predetermined operation on the input unit 19.

Next, the user makes an operation to press a shutter switch (not illustrated) of the input unit 19 to a lower limit (hereinafter referred to as “fully pressed operation”) in a state holding the image capturing device 1. Wide image combination processing is thereby initiated. The image capturing device 1 causes continuous shoot operation of the imaging unit 17 to initiate.

Next, while maintaining the fully pressed operation of the shutter switch, the user first causes the image capturing device 1 to move in a direction from left to right at the upper side of FIG. 2, next causes the image capturing device to move to the lower side in the same figure, followed by causing the image capturing device 1 to move in a direction from right to left.

While moving, the image capturing device 1 detects an amount of movement based on the detection results of the acceleration sensor 18, and repeats causing an image of the subject to be captured in the imaging unit 17 every time the amount of movement thereof reaches a predetermined amount, and storing the data of the frame images obtained as a result thereof.

More specifically, in the present example, the image capturing device 1 performs image capturing one time when the amount of movement in the horizontal direction from an initial position of image capturing (position at which fully pressed operation was initiated) reaches a predetermined amount, and then stores data of a first frame image.

Furthermore, the image capturing device 1 performs image capturing a second time when the movement amount from the image capturing position of the first time reaches a predetermined amount, and then stores data of a second frame image.

Additionally, the image capturing device 1 performs image capturing a third time when a movement amount from the image capturing position of the second time reaches a predetermined amount, and then stores data of a third frame image.

Subsequently, the image capturing device 1 stores a total amount of the movement amount in the horizontal direction (cumulative movement amount from position at which fully pressed operation was initiated) when detecting movement in the vertical direction of at least a predetermined amount.

Then, the image capturing device 1 next performs image capturing a fourth time when a movement amount in the horizontal direction from the position at which movement in the vertical direction of at least a predetermined amount was detected reaches a predetermined amount, and then stores data of a fourth frame image.

Furthermore, the image capturing device 1 performs image capturing a fifth time when the movement amount from the image capturing position of the fourth time reaches a predetermined amount, and then stores data of a fifth frame image.

Additionally, the image capturing device 1 performs image capturing a sixth time when the movement amount from the image capturing position of the fifth time reaches a predetermined amount, and then stores data of a sixth frame image.

Subsequently, the image capturing device 1 causes continuous shoot action of the imaging unit 17 to end when detecting movement of the same amount as the movement amount prior to detecting movement in the vertical direction of at least a predetermined amount.

When this is done, the image capturing device 1 performs wide image combination processing on the data of the first to sixth frame images thus stored, and then generates data of a wide image.

FIG. 3 is a schematic diagram showing an outline of wide image combination processing of the image capturing device 1.

The image capturing device 1 generates data of an upper panoramic image by combining data of the first to third frame images thus stored in the order of capture, by way of panoramic image data generation processing.

In addition, the image capturing device 1 generates data of a lower panoramic image by combining data of the fourth to sixth frame images stored in the order of capture, by way of panoramic image data generation processing.

Then, the image capturing device 1 combines the data of the upper panoramic image and the data of the lower panoramic image by way of vertical combination processing to generate data of a wide image.

FIG. 4 is a schematic diagram showing an outline of the vertical combination processing of the wide image combination processing.

The image capturing device 1 generates an energy map from the data of the upper panoramic image and the data of the lower panoramic image in the vertical combination processing. In the present embodiment, an “energy map” is generated as follows. Specifically, for the data of the upper panoramic image, the degree of similarity between a specific pixel (pixel of interest) in the upper panoramic image and another pixel, and the degree of similarity between a pixel at a position corresponding to the pixel of interest in the lower panoramic image (corresponding pixel) and another pixel are calculated. Then, based on these degrees of similarity, the energy value is calculated at every pixel. The energy value at every pixel calculated is an “energy map” expressing a distribution on a two-dimensional plane, and is used in the generation of an α blend map described later. In addition, in the present embodiment, “energy value” is a smaller value as pixels become more similar, and is a larger value as pixels become dissimilar.

Herein, “pixel of interest” is a pixel that should be given attention as a processing target, and each pixel constituting the panoramic image of a processing target (e.g., upper panoramic image in the present embodiment) is sequentially set in so-called raster order.

Next, the image capturing device 1 analyzes the energy map, and generates an α blend map. In the present embodiment, “α blend map” is a map setting the transmittance of data of the lower panoramic image relative to the data of the upper panoramic image upon combining the data of the upper panoramic image and the data of the lower panoramic image, and is an image (distribution on a two-dimensional plane of the transmittance of each pixel) constituted from each pixel having transmittance as a pixel value, with the resolution being the same as the frame images.

For example, the function of the α blend map in a case of superimposing the data of the lower panoramic image on the data of the upper panoramic image will be explained hereinafter.

It should be noted that, in the following explanation, transmittance will be explained with numerical values of 0 to 100 for convenience of explanation.

A transmittance of 0 indicates the data of the lower panoramic image being applied as is to the data of the upper panoramic image upon combining.

A transmittance of 100 indicates that the data of the lower panoramic image is entirely not applied to the data of the upper panoramic image upon combining.

If the transmittance is a value between 0 and 100, depending on the value thereof, it indicates the data of the upper panoramic image and the data of the lower panoramic image being blended upon combining. Regarding “depending on the value thereof”, if a value close to 0, for example, a factor of the data of the lower panoramic image is blended more than a factor of the data of the upper panoramic image. In addition, if a value close to 100, the factor of the data of the upper panoramic image is blended more than the factor of the data of the lower panoramic image.

In the α blend map of FIG. 4, the black portion B has a transmittance of 0, the hatched portion G has a transmittance with values between 0 and 100, and the white portion W has a transmittance of 0.

The image capturing device 1 combines the data of the upper panoramic image and the data of the lower panoramic image using this α blend map to generate a wide image.

Data of the wide image thereby becomes data in which the data of the lower panoramic image is applied as is in the black portion B, data in which the data of the upper panoramic image and the data of the lower panoramic image are blended is applied in the hatched portion G, and the data of the upper panoramic image is applied as is in the white portion W.

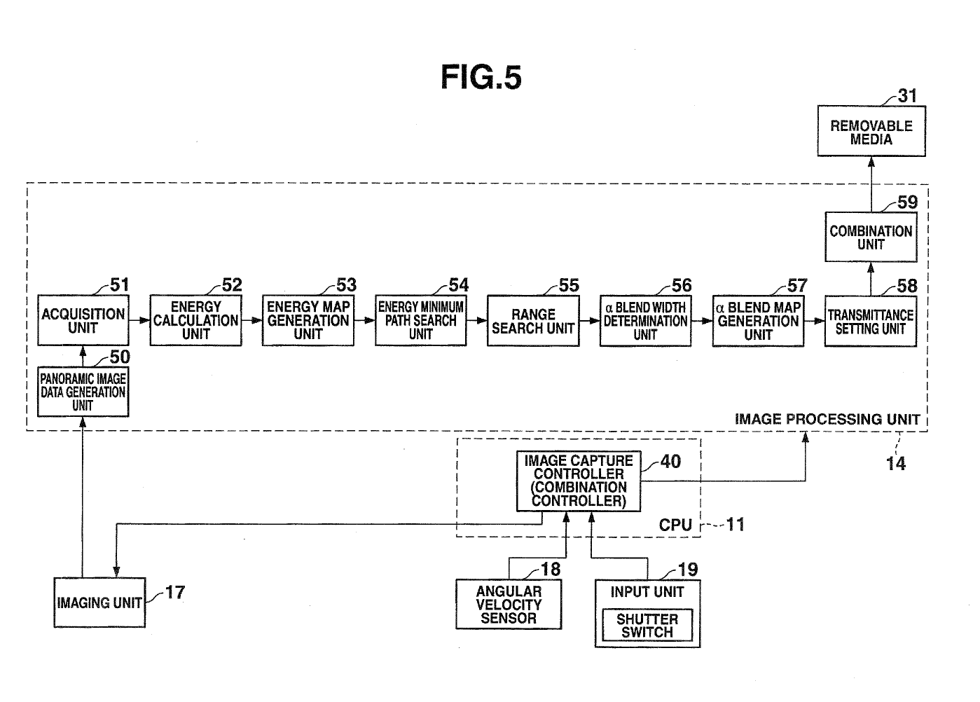

Next, the functional configuration of the image capturing device 1 for executing such wide image combination processing will be explained while referencing FIG. 5.

FIG. 5 is a functional block diagram showing, among the functional configurations of the image capturing device 1 in FIG. 1, the functional configuration for executing wide image combination processing.

In a case of the image capturing device 1 executing wide image combination processing, an imaging controller (combination controller) 40 functions in the CPU 11, and under the control of this imaging controller 40, a panoramic image data generation unit 50, acquisition unit 51, energy calculation unit 52, energy map generation unit 53, energy minimum path search unit 54(energy path determination unit 54), range search unit 55, α blend width determination unit 56, α blend map generation unit 57, transmittance setting unit 58, and combination unit 59 function in the image processing unit 14.

The imaging controller 40 controls the timing of image capturing of the imaging unit 17.

More specifically, while in the wide mode, wide image combination processing initiates when the user makes a fully pressed operation while holding the image capturing device 1. In other words, the imaging controller 40 causes continuous shoot action of the imaging unit 17 to initiate.

Subsequently, the user causes the image capturing device 1 to move in the horizontal direction, e.g., from a left side to a right side of the subject, in a state maintaining the fully pressed operation of the shutter switch of the input unit 19. Next, the user causes the image capturing device 1 to move in the vertical direction, e.g., from above to below the subject, in a state maintaining the fully pressed operation of the shutter switch. Then, the user causes the image capturing device 1 to move in the horizontal direction, e.g., from a right side to a left side of the subject, in a state maintaining the fully pressed operation of the shutter switch.

The imaging controller 40, based on the detection results of the acceleration sensor 18, repeats causing the imaging unit 17 to capture an image every time the movement amount in the horizontal direction of the image capturing device 1 reaches a certain amount while the fully pressed operation is maintained, and temporarily storing data of the frame image obtained as a result thereof in a frame buffer of the storage unit 21.

In addition, the imaging controller 40 stores a total movement amount in the horizontal direction (cumulative movement amount from position at which fully pressed operation was initiated), when detecting movement of the image capturing device 1 of at least a predetermined amount in the vertical direction.

Subsequently, with the imaging controller 40, when the total movement amount in the horizontal direction after movement of the image capturing device 1 in the vertical direction reaches the total movement amount stored (total amount of the movement amount prior to detecting movement in the vertical direction), the imaging controller 40 causes continuous shoot action of the imaging unit 17 to end.

The panoramic image data generation unit 50 generates data of a panoramic image by combining, in order of capture, the data of frame images captured by way of the imaging unit 17 and temporarily stored in the frame buffer.

In detail, the panoramic image data generation unit 50 acquires data of a plurality of frame images captured in a period from fully pressing the shutter switch until movement of the image capturing device 1 in the vertical direction is detected. The panoramic image data generation unit 50 synthesizes the data of these frame images to generate data of one panoramic image (e.g., data of upper panoramic image shown in FIG. 3).

In addition, the panoramic image data generation unit 50 acquires data of a plurality of frame images captured in a period after the detection of movement of the image capturing device 1 in the vertical direction until continuous shoot action of the imaging unit 17 is finished. The panoramic image data generation unit 50 combines data of these frame images horizontally to generate data of one panoramic image (e.g., data of the lower panoramic image shown in FIG. 3).

In the image processing unit 14 explained below, the acquisition unit 51, energy calculation unit 52, energy map unit 53, energy minimum path search unit 54, range search unit 55, α blend width determination unit 56, α blend map generation unit 57, transmittance setting unit 58 and combination unit 59 are a functional configuration for the image capturing device 1 to execute the processing of combining data of a plurality of panoramic images generated by way of the panoramic image data generation unit 50 in the vertical direction.

The acquisition unit 51 acquires data of a plurality of panoramic images generated by the panoramic image data generation unit 50.

The energy calculation unit 52 calculates the energy values corresponding to pixels of interest in the data of one image, based on the data of one image in the data of a plurality of panoramic images acquired by the acquisition unit 51 and the data of another image that is a combination target of this one image.

More specifically, the energy calculation unit 52 obtains the energy value at every pixel for the data of one image (e.g., data of upper panoramic image), among the data of two images (e.g., data of upper panoramic image and data of lower panoramic image shown in FIG. 3) to be the combination target of the data of a plurality of panoramic images acquired by the acquisition unit 51, based on the degree of similarity between the pixel of interest in one image (e.g., upper panoramic image) and another pixel and the degree of similarity of another pixel in another image (e.g., lower panoramic image) and the pixel of interest.

The energy map generation unit 53 generates, as an energy map, a distribution of the energy value of every pixel of interest calculated by the energy calculation unit 52 on a two-dimensional plane.

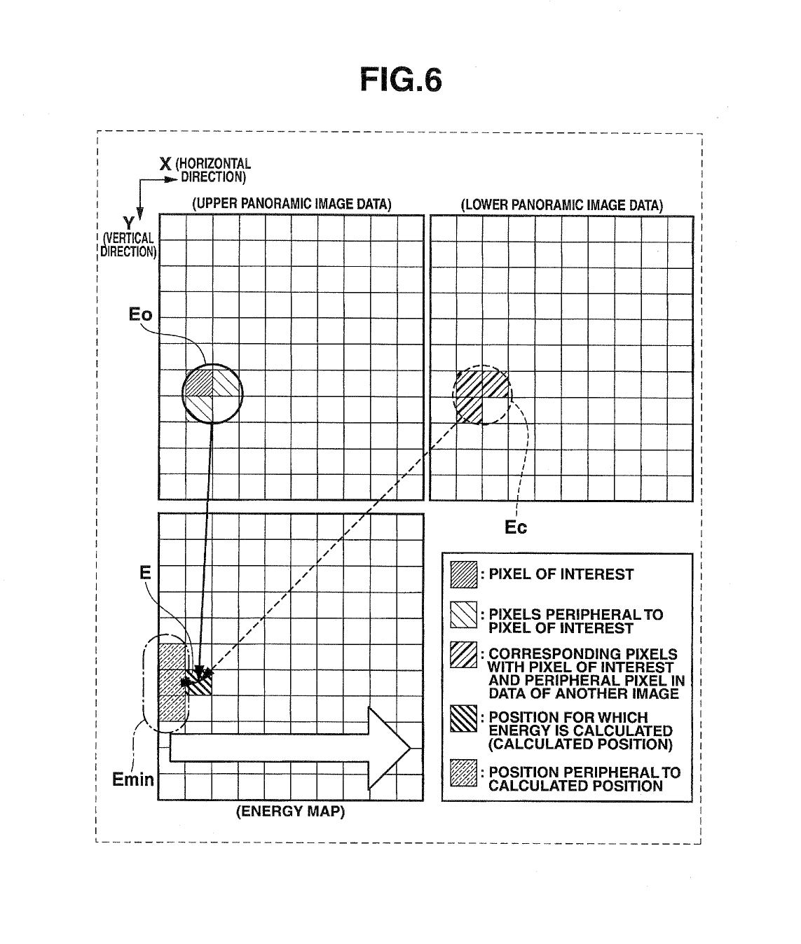

FIG. 6 is a schematic diagram showing an example of an energy map generation technique of the energy map generation unit 53.

FIG. 6 shows a portion of the data of the upper panoramic image, a portion of the data of the lower panoramic image, and a portion of an energy map expressing the degree of similarity between the pixel of interest and a peripheral pixel thereof between data of the upper panoramic image and the data of the lower panoramic image.

In addition, FIG. 6 and FIGS. 7 to 10 described later show a plurality of boxes arranged by X (horizontal direction) and Y (vertical direction), respectively. Each box indicates one pixel.

As shown in FIG. 6, the energy map generation unit 53 calculates the energy value of each pixel sequentially from the left side to the right side in FIG. 6.

An example will be explained of a technique for the energy map generation unit 53 to calculate the energy value of each pixel in the generation of an energy map.

The energy map generation unit 53 calculates the energy value E shown in FIG. 6, as follows.

The energy map generation unit 53 calculates a degree of similarity energy value Eo based on the degree of similarly between a pixel of interest (coordinates (x,y)) of the upper panoramic image shown in FIG. 6 and an adjacent pixel (coordinates (x+n, y+m)) at the periphery of this pixel of interest.

For example, only a part of the pixels in the periphery as in FIG. 6 may be used for the peripheral pixel.

In addition, the energy map generation unit 53 calculates a degree of similarity energy value Ec in the data of the lower panoramic image shown in FIG. 6, based on the degree of similarity between a corresponding pixel of interest (coordinates (x,y)) disposed at a position corresponding to the arranged position of the pixel of interest of the upper panoramic image and a pixel adjacent to this corresponding pixel of interest in the horizontal direction (coordinates (x+n, y+m)).

For example, only a part of the pixels in the periphery as in FIG. 6 may be used for the peripheral pixel.

Furthermore, among the pixels for which energy value has already been calculated, the energy map generation unit 53 calculates a lowest energy value Emin in the energy map shown in FIG. 6, among the energies of a pixel (adjacent pixels), in a column before a pixel for which a current energy value E was calculated, adjacent to this pixel, and of pixels above and below this adjacent pixel. It should be noted that, although the energy map generation unit 53 calculates the lowest energy value Emin from among three pixels of a previous column in the present embodiment, it is not limited thereto. For example, depending on the characteristics between the data of the lower panoramic image and the data of the upper panoramic image, the lowest energy value Emin can be calculated from among five pixels of a previous column.

The energy map generation unit 53 calculates the energy value E based on the degree of similarity energy value Eo, corresponding degree of similarity energy value Ec and energy value Emin thus calculated.

Herein, in the present example, although the energy value E is obtained by calculating Eo, Ec and Emin with the pixel of interest of the upper panoramic pixel as a reference, the energy value E may be obtained by calculating Eo, Ec and Emin with the pixel of interest of the lower panoramic image as a reference.

Returning back to FIG. 5, the energy minimum path search unit 54 searches for an energy minimum path on which the energy value is the lowest in a horizontal direction of the energy map generated by the energy map generation unit 53.

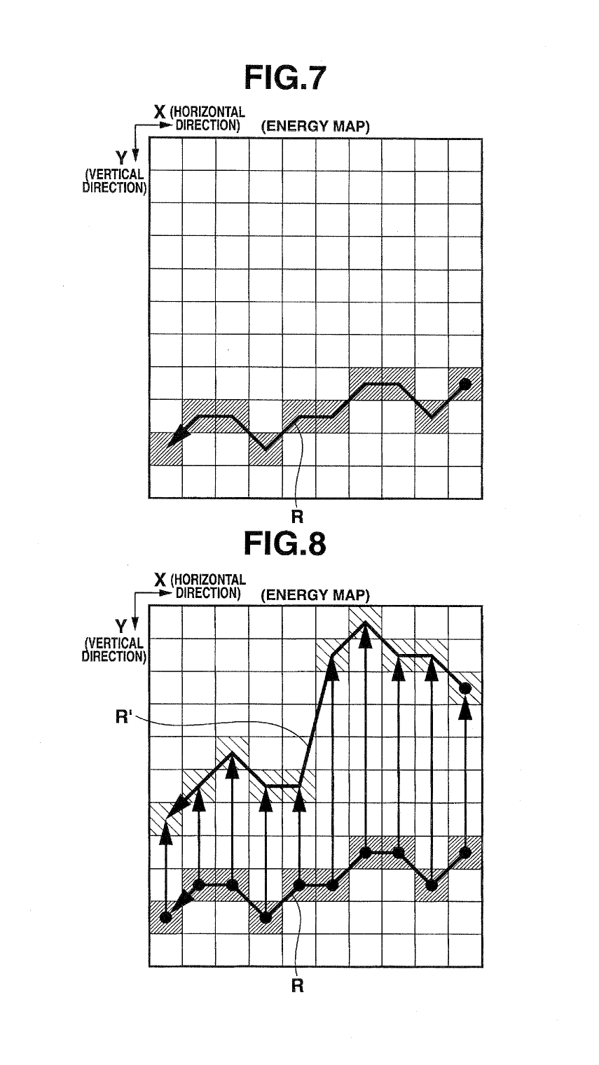

FIG. 7 is a schematic diagram showing an example of a technique for searching for the energy minimum path of the energy minimum path search unit 54.

The energy map generated by the energy map generation unit 53 is shown in FIG. 7.

The energy minimum path search unit 54 searches for a path on which the energy value of the data of the pixels of interest each calculated by the energy calculation unit 52 is a minimum. In detail, the energy minimum path search unit 54 searches for an energy minimum path in the X direction (horizontal direction) towards an opposite direction to the direction in which the energy map was generated by the energy map generation unit 53. In other words, the energy minimum path is searched for in the energy map from a column for which the energy value was calculated by the energy map generation unit 53 last, towards the column for which the energy value was calculated first.

More specifically, the energy minimum path search unit 54 searches for a pixel having the lowest energy value, in the column for which the energy value was calculated by the energy map generation unit 53 last. Next, the energy minimum path search unit 54 searches for a pixel having the lowest energy value among the energies of an adjacent pixel to the searched pixel and pixels above and below this adjacent pixel. The energy minimum path search unit 54 searches for an energy minimum path R by performing the same search until a column for which the energy value was calculated first by the energy map generation unit 53.

In addition, the search of the energy minimum path R is not limited to the aforementioned method, and may be performed by a graph cut technique, for example. It should be noted that the graph cut technique will not be explained in detail in the present example due to having been disclosed in “Interactive Digital Photomontage,” A. Agarwala et al. ACM SIGGRAPH, 2004, for example.

Returning back to FIG. 5, the range search unit 55 searches for and determines a range of pixels having values close to the value of the specific pixel of interest in the vertical direction within the data of one image on the energy minimum path searched by the energy minimum path search unit 54. In addition, the range search unit 55 searches for and determines a path on which the energy value is minimum, in a direction orthogonal to a predetermined direction of the energy map generated by the energy map generation unit 53 (That is, the range search unit 55 searches for and determines a path on which each of the energy values is minimum in the vertical direction.).

FIG. 8 is a schematic diagram showing an example of a technique of the range search unit 55 for searching for and determining the range of pixels having values close to the value of the specific pixel of interest in the vertical direction within the data of one image on the energy minimum path.

In FIG. 8, the energy map generated by the energy map generation unit 53, and the energy minimum path R in this energy map searched by the energy minimum path search unit 54 are shown.

The range search unit 55 searches and determines, in the Y direction (vertical direction) of the energy map, for a pixel having a differential in energy value from the energy value on the energy minimum path R that is within a predetermined degree of flatness. The range search unit 55 searches for and determines a range R′ that is within a predetermined degree of flatness, by searching for and determining pixels that are within a predetermined degree of flatness for the specific pixel on the energy minimum path R in the vertical direction. In the present embodiment, “predetermined degree of flatness” refers to the differential in energy value from the energy value of each pixel on the energy minimum path R being within a predetermined value, for example. Furthermore, in addition to the absolute value of a difference in brightness value of pixels, for example, “differential in energy value” can employ the variation in hue value or color difference value.

In other words, the range search unit 55 searches for and determines a width of pixels having values (falling with a predetermined value) close to the value (brightness value, hue value, color difference value, etc.) of the specific pixel on the energy minimum path R in the vertical direction, as the range R′.

In addition, the range search unit 55 can also search for and determines a range that is within the predetermined degree of flatness, by performing weighting. “Weighting” can be performed by multiplying, or adding, a value depending on the magnitude of energy value of each pixel on the energy minimum path R, or a value depending on the distance from the energy minimum path R, by, or to, the differential in actual energy value.

Returning back to FIG. 5, the α blend width determination unit 56 determines the blend width defining the energy minimum path as the origin, based on the range of pixels searched by the range search unit 55. In detail, the α blend width determination unit 56 searches, in a predetermined direction of the energy map, for a range having a differential in energy value from the path searched by the energy minimum path search unit 54 that is within a predetermined degree of flatness, as a range of pixels having values close to the value of the specific pixel, and then determines this as the blend width.

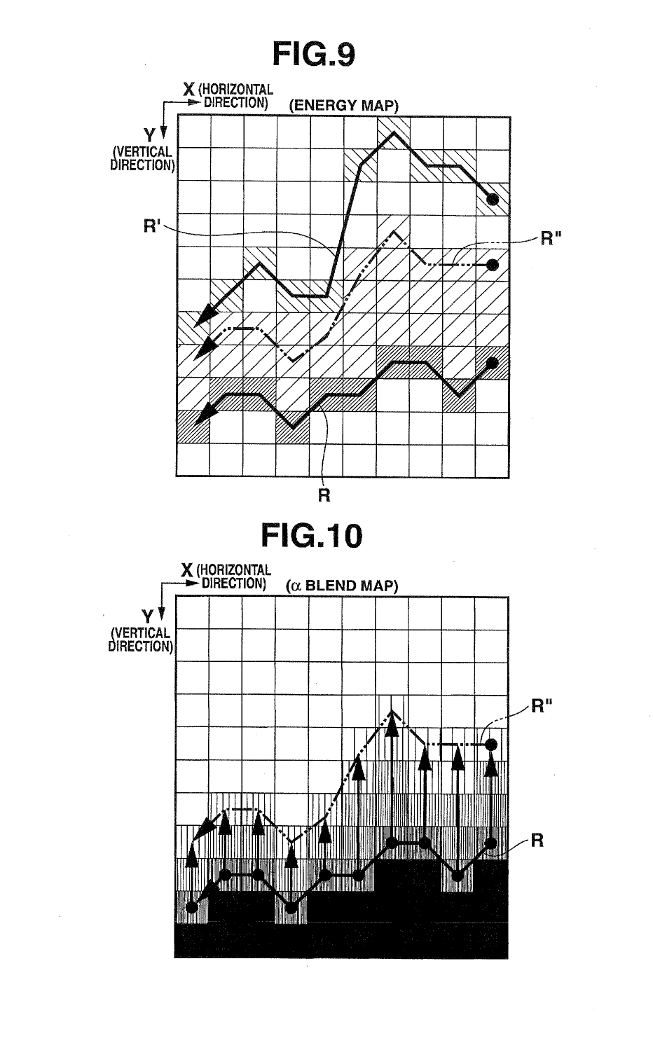

FIG. 9 is a schematic diagram showing an example of a technique of the α blend width determination unit 56 to determine the blend width.

The energy map generated by the energy map generation unit 53, and the range R′ searched by the range search unit 55, in this energy map, that is within a predetermined degree of flatness with the energy minimum path R searched by the energy minimum path search unit 54 are shown in FIG. 9.

The α blend width determination unit 56 calculates an α blend width terminal path R″ serving as one end of the α blend width, the energy minimum path R being defined as the other end thereof.

More specifically, the α blend width determination unit 56 defines an adjacent pixel, to a pixel serving as the starting point of the energy minimum path R, in the direction of combining the data of a plurality of panoramic images, i.e. in the Y direction (vertical direction), as a starting point of the α blend width terminal path R″. The α blend width determination unit 56 searches for pixels forming the α blend width terminal path R″, in the same direction as the energy minimum path R from peripheral pixels of the pixel serving as this starting point. By a similar method, the α blend width determination unit 56 searches, in the same direction as the energy minimum path R, for pixels forming the α blend width terminal path R″ in sequence from peripheral pixels of the searched pixel. The α blend width determination unit 56 searches for pixels forming the α blend width terminal path R″, based on the magnitude of the energy values of the pixels of the range R′ that are within a predetermined degree of flatness with the energy minimum path R in a predetermined column of the energy map, for example.

In addition, the α blend width determination unit 56 can also determine the blend width by performing weighting. “Weighting” can be performed by multiplying, or adding, a value depending on the magnitude of the energy value of each pixel on the energy minimum path R, or a value depending on the distance from the energy minimum path R, by, or to, the differential in energy value of a pixel of the range R′ that is within a predetermined degree of flatness with the energy minimum path R in a predetermined column of the energy map, for example.

In addition, “weighting” can be performed by multiplying, or adding, a value depending on image capturing conditions of the image capturing device 1, by, or to, the energy value of a pixel of the range R′ that is within a predetermined degree of flatness with the energy minimum path R in a predetermined column of the energy map, for example. Herein, “image capturing conditions” are whether or not to use the flash during image capturing or the like, for example.

Returning back to FIG. 5, the α blend map generation unit 57 generates an α blend map establishing the transmittance of the lower panoramic image relative to the upper panoramic image, based on the blend width determined by the α blend width determination unit 56.

FIG. 10 is a schematic diagram showing an example of a technique of the α blend map generation unit 57 to generate the α blend map.

In FIG. 10, the energy minimum path R searched by the energy minimum path search unit 54, and the α blend width terminal path R″ calculated by the α blend width determination unit 56, which are used in the explanation, are shown on the α blend map generated by the α blend map generation unit 57.

The α blend map generation unit 57 generates an α blend map in which the transmittance varies from a pixel forming the energy minimum path R towards the Y direction (vertical direction), until a pixel forming the α blend width terminal path R″, in each column of pixels.

More specifically, the α blend map generation unit 57 generates a blend map in which the transmittance varies from 0 to 100, in every column of pixels, between the pixel forming the energy minimum path R and the pixel forming the α blend width terminal path R″. In other words, the degree of variation in transmittance differs according to the distance between the pixel forming the energy minimum path R and the pixel forming the α blend width terminal path R″.

Returning back to FIG. 5, the transmittance setting unit 58 sets the transmittance corresponding to a map generated by the α blend map generation unit 57. In other words, the transmittance setting unit 58 sets the transmittance of the lower panoramic image relative to the upper panoramic image, based on the blend width determined by the α blend width determination unit 56.

The combination unit 59 combines the respective data of the upper panoramic image and lower panoramic image, using the α blend map generated by the α blend map generation unit 57, i.e. based on the blend width determined by the α blend width determination unit 56 and the transmittance set by the transmittance setting unit 58, so as to generate the data of a wide image (refer to FIG. 4).

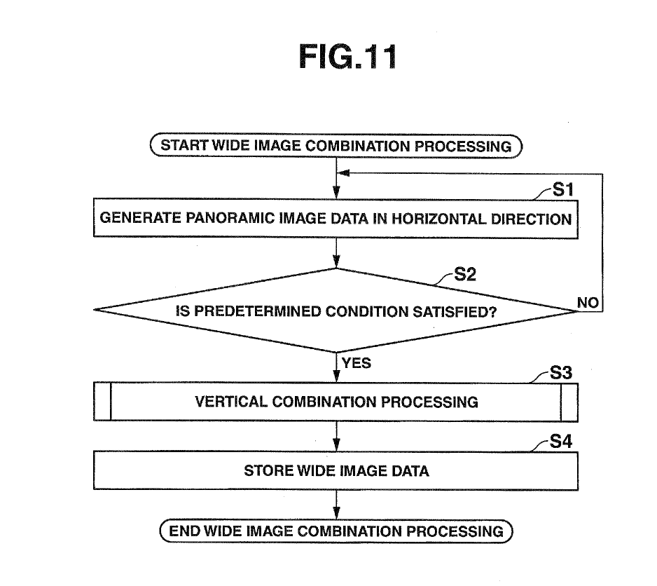

Next, among the processing executed by the image capturing device 1 of FIG. 1 having such a functional configuration of FIG. 5, the flow of wide image combination processing will be explained while referencing FIG. 11.

FIG. 11 is a flowchart illustrating the flow of wide image combination processing executed by the image capturing device 1.

In the present embodiment, wide image combination processing is initiated on the event of the operation mode of the image capturing device 1 being switched to wide mode, after which the user fully presses the shutter switch (not illustrated) of the input unit 19 to make an instruction for image capturing.

In Step S1, the panoramic image data generation unit 50 generates data of a panoramic image by combining the data of frame images captured in the imaging unit 17 and temporarily stored in the frame buffer in the order of capture.

In Step S2, the combination controller 40 determines whether or not predetermined conditions have been satisfied, advancing the processing to Step S3 in the case of having determined that the predetermined conditions have been satisfied, and returning the processing to Step S1 in the case of having determined that the predetermined conditions have not been satisfied. In the present embodiment, “predetermined conditions” refers to the matter of the data of two panoramic images being generated by the image capturing device 1 being moved in the horizontal direction, followed by being moved in the vertical direction, and further being moved in the horizontal direction.

In Step S3, in the image processing unit 14, the acquisition unit 51, energy calculation unit 52, energy map generation unit 53, energy minimum path search unit 54, range search unit 55, α blend width determination unit 56, α blend map generation unit 57, transmittance setting unit 58 and synthesis unit 59 execute vertical combination processing in cooperation. Although described in detail later, in the vertical combination processing, the acquisition unit 51, energy calculation unit 52, energy map generation unit 53, energy minimum path search unit 54, range search unit 55, α blend width determination unit 56, α blend map generation unit 57, transmittance setting unit 58 and combination unit 59 combine the data of panoramic images generated by the panoramic image data generation unit 50 in Step S1 so as to generate the data of a wide image.

In Step S4, the combination controller 40 stores the data of the wide image generated in Step S3 in the removable media 31.

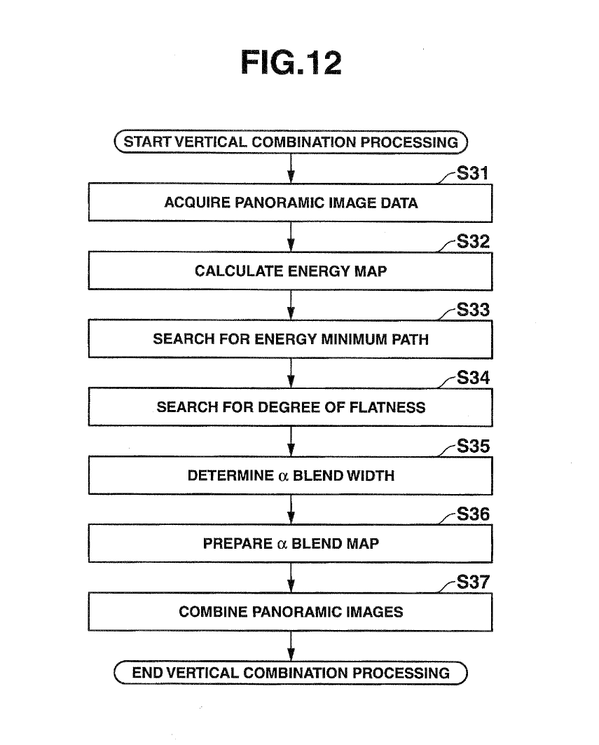

Next, among the wide image combination processing shown in FIG. 11, vertical combination processing will be explained while referencing FIG. 12.

FIG. 12 is a flowchart illustrating the flow of vertical combination processing executed by the image capturing device 1.

In Step S31, the acquisition unit 51 acquires the data of a plurality of panoramic images generated by the panoramic image data generation unit 50 in Step S1 (e.g., data of the upper panoramic image and data of the lower panoramic image shown in FIG. 3).

In Step S32, the energy calculation unit 52 respectively calculates the energies corresponding to the pixels of interest in the data of the upper panoramic image, based on the data of the upper panoramic image and the data of the lower panoramic image in the plurality of panoramic images acquired by the acquisition unit 51 in Step S31. Then, the energy map generation unit 53 generates a distribution of energy value at every pixel of interest calculated by the energy calculation unit 52 on a two-dimensional plane as the energy map (refer to FIGS. 6A to 6C).

In Step S33, the energy minimum path search unit 54 searches for and determines a path on which each of the energies of the data of pixels of interest calculated by the energy calculation unit 52 in Step S32 is minimum among the energies of the pixels in the vertical direction. In detail, the energy minimum path search unit 54 searches for and determines the energy minimum path R (refer to FIG. 7) on which the energy value is respectively a minimum in the vertical direction of the energy map generated by the energy map generation unit 53 in Step S32.

In Step S34, the range search unit 55 searches for and determines the range of pixels having values close to the value of the specific pixel of interest on the energy minimum path in the data of the upper panoramic image on the energy minimum path searched by the energy minimum path search unit 54 in Step S33. In detail, the range search unit 55 searches for and determines, in the vertical direction of the energy map (direction of combining the data of a plurality of panoramic images), the range R′ (refer to FIG. 8) for which a differential in energy values from the energy minimum path R searched by the energy minimum path search unit 54 in Step S33 is within a predetermined degree of flatness.

In Step S35, the α blend width determination unit 56 determines the blend width with the energy minimum path as the origin, based on the range of pixels searched by the range search unit 55 in Step S34. In detail, the α blend width determination unit 56 determines the blend width (refer to FIG. 9) with the energy minimum path R searched by the energy minimum path search unit 54 as the origin, based on the range R′ that is within a predetermined degree of flatness searched by the range search unit 55 in Step S34. In FIG. 9, R″ is at a substantially middle position between R and R′, and in this case, the α blend width determination unit 56 determines a pixel amount between R and R″ as the blend width.

In Step S36, the α blend map generation unit 57 generates the α blend map (refer to FIG. 10) setting the transmittance of the lower panoramic image relative to the upper panoramic image, based on the blend width determined by the α blend width determination unit 56 in Step S35. The transmittance setting unit 58 sets the transmittance corresponding to the α blend map generated by the α blend map generation unit 57.

Herein, as a way of setting transmittance, it is configured so as to set the transmittance of the lower panoramic image relative to the upper panoramic image; however, the present embodiment is not limited thereto.

In other words, it may be configured so as to set the transmittance of the upper panoramic image relative to the lower panoramic image.

In Step S37, the combination unit 59 combines the respective data of the upper panoramic image and the lower panoramic image using the α blend map generated by the α blend map generation unit 57 in Step S36, i.e. based on the blend width determined by the α blend width determination unit 56 in Step S35 and the transmittance set by the transmittance setting unit 58 in Step S36, so as to generate the data of a wide image (refer to FIG. 4).

As explained in the foregoing, the image capturing device 1 of the present embodiment includes, in the image processing unit 14, the energy calculation unit 52, energy map generation unit 53, energy minimum path search unit 54, range search unit 55, α blend width determination unit 56, α blend map generation unit 57, transmittance setting unit 58 and combination unit 59.

The image capturing device 1 is an image processing device that generates the data of a wide image by combining data of a plurality of images in a predetermined direction.

The energy calculation unit 52 calculates the energies corresponding to the pixels of interest in one image, based on one image in the data of the plurality of images and another image that is the combination target of this one image.

The energy minimum path search unit 54 searches for and determines the energy minimum path R on which the each of energy values of the pixels of interest calculated by the energy calculation unit 52 is minimum among the energy values of pixels in the vertical direction.

The range search unit 55 searches for and determines a range of pixels having values close to the value of the specific pixel of interest in one image on the energy minimum path R searched by the energy minimum path search unit 54.

The α blend width determination unit 56 determines a blend width with the energy minimum path as the origin, based on the range of pixels searched by the range search unit 55.

The transmittance setting unit 58 sets the transmittance of one image relative to the other image, based on the blend width determined by the α blend width determination unit 56.

The combination unit 59 combines the one image and the other image based on the blend width and the transmittance set by the transmittance setting unit 58.

It is thereby possible to search the energies corresponding to the pixels of interest in the one image, based on the other image that is the combination target, for the energy minimum path to serve as the connection portion of the data of a plurality of images. Then, the transmittance of the other image relative to the one image is set in the blend width defining this energy minimum path as the origin, whereby the data of a plurality of images can be combined.

Therefore, it is possible to decrease the sense of strangeness about a connecting portion in an image of a wide range after combination.

The energy map generation unit 53 generates a distribution of energy value for every pixel of interest calculated by the energy calculation unit 52 on a two-dimensional plane as an energy map.

The range search unit 55 searches for and determines a path on which each of the energy values is minimum among the energy values in the vertical direction.

It is thereby possible to search the energy map for an energy minimum path to serve as a connecting portion of the data of a plurality of images. Then, the transmittance of the other image relative to the one image is set for the blend width with this energy minimum path as the origin, whereby the data of a plurality of images can be combined.

Therefore, it is possible to decrease the sense of strangeness about a connecting portion of an image of a wide range after combination.

The α blend width determination unit 56 searches for and determines, in a predetermined direction(in the vertical direction) of the energy map, a range in which the differential in energy values from the energy minimum path R searched by the energy minimum path search unit 54 is within a predetermined degree of flatness, as a range of pixels having values close to the value of the corresponding pixel of interest.

It is thereby possible to determine the range for which the differential in energy values from the energy minimum path is within a predetermined degree of flatness as the blend width.

Therefore, by determining the range of the predetermined degree of flatness as the blend width, it is possible to further decrease the sense of strangeness about the connecting portion of an image of a wide scope after combination.

The α blend map generation unit 57 generates an α blend map for setting the transmittance by way of the transmittance setting unit 58.

The transmittance setting unit 58 sets the transmittance corresponding to the α blend map generated by the α blend map generation unit 57.

It is thereby possible to set the transmittance corresponding to the α blend map to combine the data of a plurality of images.

Therefore, it is possible to decrease the sense of strangeness about a connecting portion of an image of a wide range after combination.

The α blend map generation unit 57 generates a blend map in which the transmittance varies in a combination direction (in the vertical direction) of the data of a plurality of images, with the energy minimum path R as the origin.

Therefore, the sense of strangeness about the connecting portion in the image of wide range after combination can be further decreased by having the transmittance vary in the blend width of the blend map.

In addition, since the image capturing device 1 generates data of a wide image by combining at least a portion of the data of a plurality of images in the vertical direction, it is possible to decrease the sense of strangeness about the connecting portion in an image of wide range after combination, in a case of combining the data of a plurality of images in the vertical direction.

It should be noted that the present invention is not limited to the aforementioned embodiment, and that modifications, improvements, and the like within a scope that can achieve the object of the present invention are included in the present invention.

For example, in the aforementioned embodiment, the data of two panoramic images is generated by causing the image capturing device 1 to move in the horizontal direction, followed by causing to move in the vertical direction, and then further causing to move in the horizontal direction; however, it is not limited thereto. For example, the data of three panoramic images may be generated by causing the image capturing device 1 to move in the horizontal direction, then move in the vertical direction, and to further move in the horizontal direction, followed by causing to further move in the vertical direction, and move in the horizontal direction. Similarly, the data of n+1 panoramic images may be generated by performing movement of the image capturing device 1 in the horizontal direction n+1 times, and performing a vertical movement between horizontal movements for a total of n times (n being an integer).

In addition, in the aforementioned embodiment, the energy calculation unit 52, energy map generation unit 53, energy minimum path search unit 54, range search unit 55, α blend width determination unit 56, α blend map generation unit 57, transmittance setting unit 58 and combination unit 59 are explained as a functional configuration for the image capturing device 1 to execute processing for combining the data of a plurality of panoramic images generated by the panoramic image generation unit 50 in the vertical direction; however, it is not limited thereto. For example, the energy calculation unit 52, energy map generation unit 53, energy minimum path search unit 54, range search unit 55, α blend width determination unit 56, α blend map generation unit 57, transmittance setting unit 58 and combination unit 59 may be defined as a functional configuration for executing processing to combine the data of a plurality of images in the horizontal direction.

In this case, the energy calculation unit 52 calculates the energy value of each pixel in sequence in the vertical direction, and the energy map generation unit 53 generates an energy map according to the energies calculated by the energy calculation unit 52.

In the vertical direction, the energy minimum path search unit 54 searches for the energy minimum path in an opposite direction to the direction in which the energy map was generated by the energy map generation unit 53.

The range search unit 55 searches, in the horizontal direction of the energy map (direction of combining data of the plurality of panoramic images), for a range in which the difference in energy from the energy minimum path searched by the energy minimum path search unit 54 is within a predetermined degree of flatness.

The α blend width determination unit 56 searches, in the same direction as the energy minimum path (vertical direction), for pixels forming the α blend width terminal path, and determines the blend width.

The α blend map generation unit 57 generates an α blend map setting the transmittance of an image on the left side relative to an image on the right side, for example, based on the blend width determined by the α blend width determination unit 56.

The transmittance setting unit 58 sets the transmittance according to the α blend map generated by the α blend map generation unit 57.

The combination unit 59 combines the respective data of the image on the right side and the image on the left side in the horizontal direction, based on the blend width and the transmittance set by the transmittance setting unit 58, so as to generate the data of a wide image.

In addition, although the image capturing device 1 to which the present invention is applied is explained with a digital camera as an example in the aforementioned embodiment, it is not particularly limited thereto.

For example, the present invention can be applied to common electronic equipment having a display control function. More specifically, the present invention is applicable to a notebook-type personal computer, a printer, a television set, a video camera, a portable-type navigation device, a mobile telephone, a portable game machine and the like, for example.

The aforementioned sequence of processing can be made to be executed by hardware, or can be made to be executed by software.

In other words, the functional configuration in FIG. 5 is merely an exemplification, and it is not particularly limited thereto. More specifically, it is sufficient so long as the functions enabling execution of the aforementioned sequence of processing as a whole are imparted to the image capturing device 1, and what kind of functional blocks are used in order to execute these functions are not particularly limited to the example of FIG. 5. For example, it may be configured so that the functional block functioning in the CPU 11 functions in the image processing unit 14, or conversely, it may be configured so that the functional block functioning in the image processing unit 14 functions in the CPU 11.

In addition, one functional block may be configured by a single piece of hardware, configured by a single piece of software, or may be configured by combining these.

In the case of having the sequence of processing executed by way of software, a program constituting this software is installed from the Internet or a recording medium into a computer or the like.

The computer may be a computer incorporating special-purpose hardware. In addition, the computer may be a computer capable of executing various functions by installing various programs, for example, a general-purpose personal computer.

The recording medium containing such a program is configured not only by the removable media 31 in FIG. 1 that is distributed separately from the main body of the device in order to provide the program to the user, but also is configured by a recording medium provided to the user in a state incorporated in the main body of the equipment in advance, or the like. The removable media 31 is constituted by, for example, a magnetic disk (including floppy disks), an optical disk, a magneto-optical disk or the like. The optical disk is, for example, a CD-ROM (Compact Disk-Read Only Memory), DVD (Digital Versatile Disk), or the like. The magneto-optical disk is, for example, an MD (Mini-Disk), or the like. In addition, the recording medium provided to the user in a state incorporated with the main body of the equipment in advance is constituted by the ROM 12 of FIG. 1 in which a program is recorded, a hard disk included in the storage unit 21 of FIG. 1, and the like.

It should be noted that the steps describing the program recorded in the recording medium naturally include only processing performed chronologically in the described order, but is not necessarily processed chronologically, and also includes processing executed in parallel or separately.

Although several embodiments of the present invention have been explained in the foregoing, these embodiments are merely examples, and do not limit the technical scope of the present invention. The present invention can be attained by various other embodiments, and further, various modifications such as omissions and substitutions can be made in a scope not departing from the spirit of the present invention. These embodiments and modifications thereof are included in the scope and gist of the invention described in the present specification and the like, and are encompassed in the invention recited in the attached claims and equivalents thereof.

What is claimed is:

1. An image processing device, comprising:
a receiving unit that receives a first image and a second image that is a combination target of the first image;
an energy calculation unit that calculates energy values for pixels in the first image based on the first image and the second image;
an energy path determination unit that determines a path in the first image based on the calculated energy values;
a range search unit that determines, in the first image, a range of pixels whose energy values are close to one of the calculated energy values on the determined path;
a blend width determination unit that determines, based on the determined range of pixels, a blend width between the first image and the second image;
a transmittance setting unit that sets, based on the determined blend width, a transmittance between the first image and the second image; and
a combination unit that combines the first image and the second image, based on the determined blend width and the set transmittance.

2. The image processing device according to claim 1, further comprising an energy map generation unit that generates a distribution of energy values on a two-dimensional plane for pixels in the first image, as an energy map.

3. The image processing device according to claim 2, wherein the blend width determination unit determine, in a predetermined combining direction on the energy map, a range of pixels for which a difference in energy value from a pixel in the path determined by the energy path determination unit is within a predetermined degree of flatness, as the range of pixels whose values are close to one of the calculated energy values on the path.

4. The image processing device according to claim 1, further comprising a map generation unit that generates a map for setting transmittance,
wherein the transmittance setting unit sets the transmittance in accordance with the map generated by the map generation unit.

5. The image processing device according to claim 4, wherein transmittance values in the map generated by the map generation unit vary in the predetermined combining direction, from the determined path.

6. The image processing device according to claim 1,
wherein the predetermined combining direction is a vertical direction, and
wherein the combination unit combines the first image and the second image in the vertical direction.

7. The image processing device according to claim 1, further comprising:
an imaging unit; and
a generation unit that generates a first panoramic image and a second panoramic image based on images captured by the imaging unit,
wherein the first image is the first panoramic image, and the second image is the second panoramic image.

8. An image processing method executed by an image processing device, the method comprising:
receiving a first image and a second image that is a combination target of the first image;
calculating energy values for pixels in the first image based on the first image and the second image, respectively;
determining a path in the first image based on the calculated energy values;
determining, in the first image, for a range of pixels whose energy values are close to one of the calculated energy values on the determined path;
determining, based on the determined range of pixels, a blend width between the first image and the second image;
setting, based on the determined blend width, a transmittance between the first image and the second image; and
combining the first image and the second image, based on the determined blend width and the set transmittance.

9. A recording medium that records a computer readable program, the program causing the computer to execute the steps of:
receiving a first image and a second image that is a combination target of the first image;
calculating, energy values for pixels in the first image based on the first image and the second image, respectively;
determining a path in the first image based on the calculated energy values;
determining, in the first image, for a range of pixels whose energy values are close to one of the calculated energy values on the determined path;
determining, based on the determined range of pixels, a blend width between the first image and the second image;
setting, based on the determined blend width, a transmittance between the first image and the second image; and
combining the first image and the second image, based on the determined blend width and the set transmittance.
